(19) United States
(12) Patent Application Publication
(10) Pub. No.: US 2018/0053247 A1
(43) Pub. Date: Feb. 22, 2018

(54) PRODUCE SELECTION SYSTEM FOR BULK ITEMS

(71) Applicant: Wal-Mart Stores, Inc., Bentonville, AR (US)

(72) Inventors: Steven Lewis, Bentonville, AR (US); Nicholaus Adam Jones, Fayetteville, AR (US); Matthew Dwain Biermann, Fayetteville, AR (US)

(21) Appl. No.: 15/673,489

(22) Filed: Aug. 10, 2017

Related U.S. Application Data
(60) Provisional application No. 62/377,371, filed on Aug. 19, 2016.

(51) Int. Cl. G06Q 30/06; G06F 3/0484

(52) U.S. Cl. CPC G06Q 30/0643; H04N 5/247; G06F 3/04842

(57) ABSTRACT

Disclosed is a system and method for online ordering of produce items by customers. The system allows customers to visually inspect the produce they are ordering The system is useful for purchasing bulk produce items The system includes an overhead camera and a camera beneath a compartment grid repository to take images of bulk produce in containers for customer online selection.

### RELATED APPLICATIONS

This application claims the benefit of U.S. Provisional Patent No. 62/377,371, filed Aug. 19, 2016, entitled “Produce Selection System for Bulk Items,” the contents of which are incorporated by reference herein in their entirety.

### FIELD OF THE INVENTION

The invention relates generally to a produce selection system for bulk items, and specifically to a system and method of selecting bulk produce items.

### BACKGROUND

Online orders of produce are hit or miss for customers. Customers must choose the type of produce they want to purchase and the associate picks the produce for them at the time of order fulfillment. Since customers cannot visually inspect the produce they will be purchasing, there may be times where a customer is not happy with the produce item selected for them by the associate. Customers therefore tend to avoid ordering produce online. It is desirable for customers to be able to visually inspect and pick for themselves the produce they are ordering.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates a pictorial diagram of the produce selection according to the invention;

FIG. 2 illustrates a block flow diagram of the method according to the invention; and

FIG. 3 illustrates a sequence flow diagram of the method according to the invention

### DETAILED DESCRIPTION

Disclosed herein is a system bulk item selection comprising a compartment grid repository having individual grid compartments, at least one container in at least one of the individual grid compartments, wherein the at least one container contains an amount of at least one item; and a first imaging device above the compartment grid repository and a second imaging device below the compartment grid repository. The first imaging device and the second imaging device may be cameras. The first imaging device and the second imaging device may be scanners. Each of the individual grid compartments may be numbered. Each of the individual grid compartments may have an adjustable bracket system for holding the at least one container. Multiple containers may be used. The multiple containers may be various sizes. An indicator light may be used in each of the individual grid compartments. The indicator light may be an LED light. A set of indicator lights may be used in each of the individual grid compartments. A mechanical arm may be used, wherein the mechanical arm pulls the at least container from the individual grid compartment of the compartment grid repository and replaces the container. A drone may also be used, wherein the drone pulls the at least container from the individual grid compartment of the compartment grid repository and replaces the container. Mirrors may be angled to view the amount of the at least one item with the second imaging device.

Disclosed is a method of bulk item selection comprising placing an amount of at least one item in a container in each individual grid compartment of a compartment grid repository; taking a first image of the amount of the at least one item with an overhead imaging device; taking a second image of the amount of the at least one item with a bottom image device; providing a set of images comprising the first image and the second image to a customer via a customer interface on a customer device; selecting at least one container holding the amount of the at least one item from the set of images; and illuminating a selection light in the individual grid compartment of the at least one selected container. The method may further comprise collecting the at least one selected container holding the amount of the at least one item selected. The method may further comprise completing the order for customer picks up and restocking the at least one selected container of the individual grid compartment. The at least one item may be produce. A mechanical arm may be used for collecting and restocking. A drone may also be used for collecting and restocking.

In some embodiments a customer may simply choose the type of bulk produce they want to purchase. The associate, a mechanical type arm and/or a drone then selects bulk produce for the customer at the time of order fulfillment. The system allows the customer to pick for themselves exactly which bulk produce they want to purchase. The system allows the customer to visually inspect and choose the exact produce item they want to purchase and ensure it is the item the associate chooses for them. The associate may, for example, be a retail store associate, a warehouse associate, an online distribution center associate, and/or a third party associate.

The system and method of selecting bulk items, particularly bulk produce items, includes a compartment grid repository (compartment grid). Each individual grid compartment or box of the compartment grid repository may be numbered. Each individual grid compartment includes an adjustable bracket system for placing and holding containers of varying sizes in each individual grid compartment, such as clear and/or plastic produce containers.

In some embodiments, each individual grid compartment may have indicator lights, such as LED lights for indicating the status of the container of bulk produce. For example, three LED lights may be used of varying colors. A green LED light may be used to indicate the container of bulk produce is available; a red LED light may be used to indicate the container of bulk produce is sold; a blue light indicating when the associate, mechanical type arm and/or drone needs to fulfill the order; and no light when the grid compartment is empty and needs to be restocked with a container of bulk produce by the associate, mechanical type arm and/or drone.

The associate, mechanical type arm, such as a robotic type arm, and/or drone, will initially stock the compartment grid repository with containers of bulk produce. In addition, an associate, mechanical type arm and/or a drone will restock the compartment grid repository with new containers of bulk produce, one container per individual grid compartment. The drone may include a grabbing type mechanism to pick up and place the containers of bulk produce in each individual grid compartment.

At least one top camera, or scanner, mounted above the compartment grid repository, such as a high definition (HD) camera, will snap a top-down shot of the bulk produce in each container. At least one bottom camera, or scanner, mounted below the compartment grid repository, such as a high definition (HD) camera, will snap a bottom shot of the bulk produce in each container. Each individual grid compartment will have a concave mirror system (from a bottom-up perspective) which will also allow the at least one bottom camera to see the sides of the bulk produce in the containers.

With at least one top camera and one bottom camera, particularly two HD cameras, a system control application or module will algorithmically crop each individual grid compartment and collect the images for each of the individual grid compartments. The cameras can take two dimensional (2D) images for use in creating a single three dimensional (3D) composite image.

Each of the images and/or the composite image for each bulk produce item can then be displayed on a selection graphical user interface (GUI) for that particular bulk produce item. The system control application will keep track of the images, individual grid compartment location for those images, item status, etc. for the front end system.

The server includes a photo analysis module and a systems control module. The server is coupled to the cameras and receives images from the cameras. The image analysis module receives at least one two dimensional image from at least one top camera and one bottom camera and sends the two dimensional images and/or a three dimensional composite image to the GUI in response. In some embodiments, the photo analysis module of server is designed and configured to recognize the at least one two dimensional image from each of the top and bottom cameras, analyze the at least two dimensional image from each of the top and bottom cameras, and form a three dimensional composite image from the at least one two dimensional image from each of the top and bottom cameras.

The customer will then be able to browse each container of bulk produce and choose which bulk produce to buy online. Once bought, the system will flag that container of bulk produce as sold, light that item's individual grid compartment light, such as an LED light, to red, and flagged or marked in the system and in the GUI, then alert the store associate and/or mechanical arm of the order and which container of bulk produce to pull from the compartment grid repository.

The associate/mechanical type arm/drone will pull the container of bulk produce from the individual grid compartment of the compartment grid repository for order fulfillment and will replace that container of bulk produce with a new container of bulk produce. If the associate/mechanical type arm/drone is not able to restock, or if the bulk produce item is out of stock, the individual grid compartment status will be set to empty, and that item's individual grid compartment light, such as an LED light, to blue, and flagged in the system as needing replenishment.

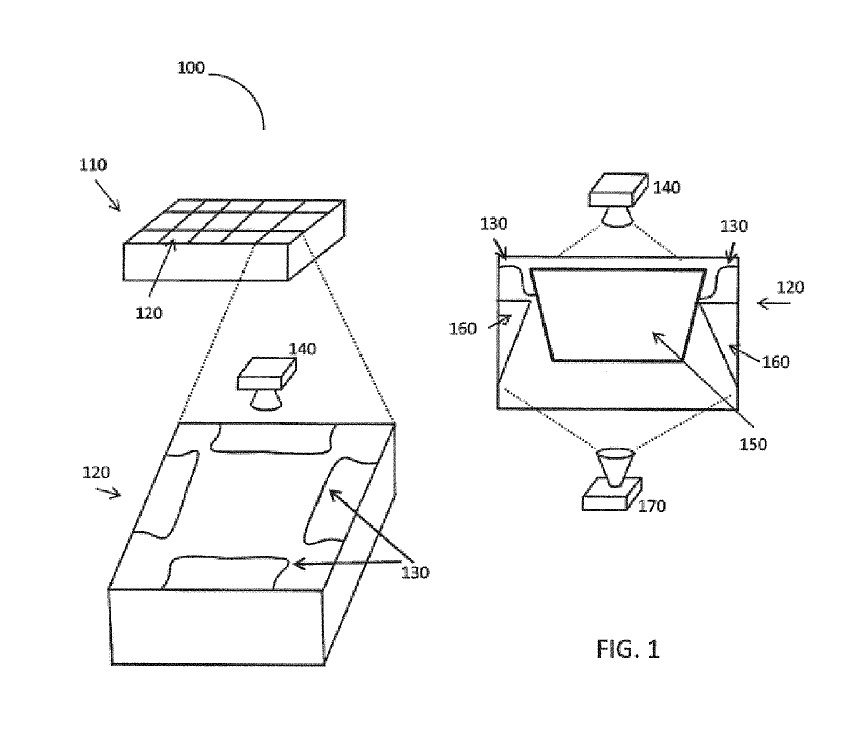

FIG. 1 illustrates bulk produce selection system 100. Compartment grid repository 110 includes individual grid compartments 120 (enlarged view). Holding brackets 130 hold containers of varying sizes in the individual grid compartments 120. An overhead camera is mounted above the compartment grid repository 110. In a side view of individual grid compartment 120, container 150 is shown with holding brackets 130. Mirrors 160 are angled to view container 150 contents from below by camera 170 mounted below the compartment grid repository 110. A side view of container 150 contents is reflected down by the mirrors 160.

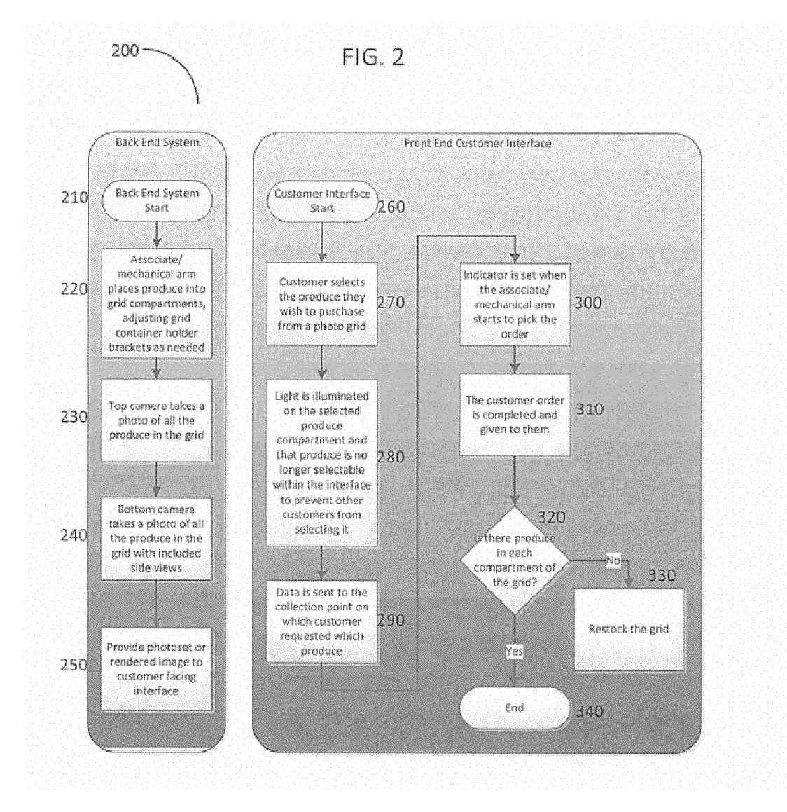

FIG. 2 illustrates method 200 of selecting bulk items, such as bulk produce. Back end system starts 210. Associate/mechanical type arm/drone places produce containers into individual grid compartments of the compartment grid repository, adjusting grid container holder brackets as needed 220. A top camera takes an image of all the containers holding the bulk produce in the grid 230. In addition, a bottom camera takes an image of all the produce in the compartment grid repository with included side views 240. A photo set or composite image forming an image grid is provided to customer facing interface 250. Customer interface starts 260. Customer selects the produce they want to purchase from the image grid 270. A light is illuminated on the individual grid compartment of the selected container of bulk produce of the compartment grid repository and that the selected container holding the bulk produce is no longer selectable within the customer interface to prevent other customers from selecting 280 and the image(s) is no longer available to other customers. Data is sent to the collection point on which customer requested which produce container 290. An indicator is set and the associate/mechanical type arm/drone starts to fulfill the order 300. The customer order is completed and customer receives order 310. The customer may pick up the order at a retail store and/or have the order delivered. The system questions if there is a produce container in each compartment of the compartment grid repository. If no, the compartment grid repository is restocked 330. If there is a produce container in each grid compartment, the system ends 340.

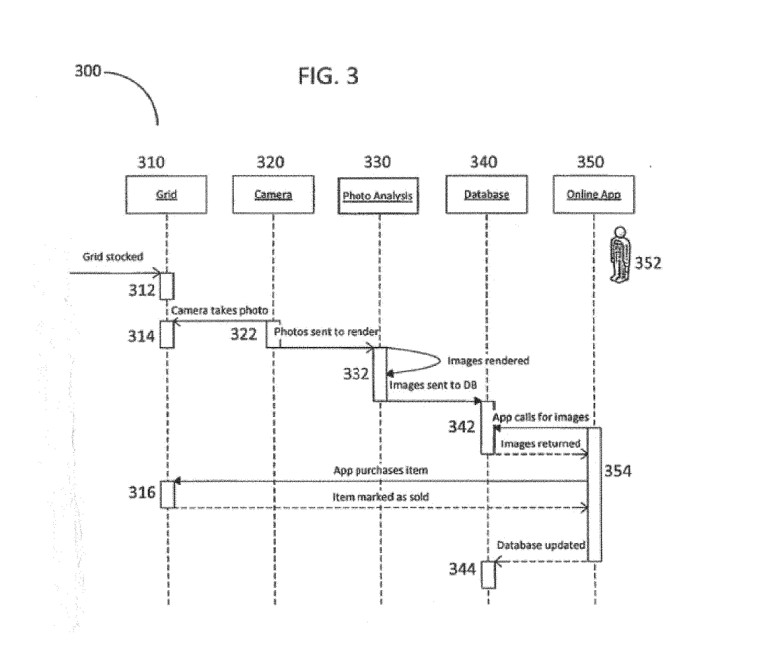

FIG. 3 illustrates a sequence diagram of method of selecting bulk produce 300. Compartment grid repository 310 is stocked 312 and overhead and/or bottom cameras 320 take two dimensional images of bulk produce, such as berries, in the container(s) 314. Cameras 320 send images for photo analysis 322. Photo analysis module 330 analyzes the images and forms a three dimensional composite image and sends to data base 340 in step 332. Customer 352 opens an application 350 on a computing device, wherein the customer requests images of a type of bulk produce for purchase and the customer views images of actual bulk produce via the application 354. The customer selects and purchases a container of bulk produce and the container containing the bulk produce is indicated as sold 316. The data base is updated as to the status of the container of bulk produce 344.

Customer interface or computing device may be any type of computing device such as a desktop or mobile computing device. The computing device may be a mobile computing device, such as a mobile phone, a tablet, a handheld computer, a portable scanner, or any other mobile computing device with the ability to communicate with a server.

As will be appreciated by one skilled in the art, aspects of the disclosed bulk produce selection system in a retail store may be embodied as an electronic system, a method, or a computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing.

Computer program code for carrying out operations for aspects of the present invention may be written in any combination of one or more programming languages, including an object oriented programming language or conventional procedural programming languages, such as the “C” programming language or similar programming languages. The program code may execute entirely on the retail store's computer, partly on the store's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or hardware accelerators or application specific integrated circuits.

While the invention has been shown and described with reference to specific preferred embodiments, it should be understood by those skilled in the art that various changes in form and detail may be made therein without departing from the spirit and scope of the invention as defined by the following claims.

What is claimed is:

1. A system for bulk item selection comprising:
a compartment grid repository having individual grid compartments,
at least one container in at least one of the individual grid compartments, wherein the at least one container contains an amount of at least one item; and
a first imaging device above the compartment grid repository and a second imaging device below the compartment grid repository.

2. The system of claim 1, wherein the first imaging device and the second imaging device are cameras.

3. The system of claim 1, wherein the first imaging device and the second imaging device are scanners.

4. The system of claim 1, wherein each of the individual grid compartments is numbered.

5. The system of claim 1, wherein each of the individual grid compartments has an adjustable bracket system for holding the at least one container.

6. The system of claim 5, further comprising multiple containers.

7. The system of claim 6, wherein the multiple containers are various sizes.

8. The system of claim 1, comprising an indicator light in each of the individual grid compartments.

9. The system of claim 7, wherein the indicator light is an LED light.

10. The system of claim 1, further comprising a set of indicator lights in each of the individual grid compartments.

11. The system of claim 1, further comprising a mechanical arm, wherein the mechanical arm pulls the at least one container from the individual grid compartment of the compartment grid repository and replaces the at least one container.

12. The system of claim 1, further comprising a drone, wherein the drone pulls the at least one container from the individual grid compartment of the compartment grid repository and replaces the at least one container.

13. The system of claim 1, further comprising mirrors angled to view the amount of the at least one item with the second imaging device.

14. A method of bulk item selection comprising:
placing an amount of at least one item in a container in each individual grid compartment of a compartment grid repository;
taking a first image of the amount of the at least one item with an overhead imaging device;
taking a second image of the amount of the at least one item with a bottom image device;
providing a set of images comprising the first image and the second image to a customer via a customer interface on a customer device;
selecting at least one of the containers holding the amount of the at least one item from the set of images; and
illuminating a selection light in the individual grid compartment of the at least one selected container.

15. The method of claim 14, further comprising collecting the at least one selected container holding the amount of the at least one item.

16. The method of claim 15, further comprising completing the order for customer picks up.

17. The method of claim 16, further comprising restocking the at least one selected container of the individual grid compartment.

18. The method of claim 14, wherein the at least one item is produce.

19. The method of claim 17, wherein a mechanical arm is used for collecting and restocking.

20. The method of claim 17, wherein a drone is used for collecting and restocking.
